(19) United States
(12) Patent Application Publication
(10) Pub. No.: US 2018/0291710 A1
(43) Pub. Date: Oct. 11, 2018

(54) Coated Nozzle Cap/Sleeve

(71) Applicants: Vijay Rajkumar, Houston, TX (US); Stephen Ward, Cypress, TX (US); Phong Vu, Houston, TX (US)

(72) Inventors: Vijay Rajkumar, Houston, TX (US); Stephen Ward, Cypress, TX (US); Phong Vu, Houston, TX (US)

(73) Assignee: Delta Screen & Filtration, LLC, Houston, TX (US)

(21) Appl. No.: 15/943,801

(22) Filed: Apr. 3, 2018

Related U.S. Application Data
(60) Provisional application No. 62/483,730, filed on Apr. 10, 2017.

(51) Int. Cl. E21B 41/00; B05B 15/18

(52) U.S. Cl. CPC E21B 41/0078; E21B 43/29; B05B 15/18

(57) ABSTRACT

Embodiments of an apparatus generally include a substantially “u” shaped cap comprising a nozzle, wherein the nozzle cap is adapted to be longitudinally positioned onto a shunt tube and welded thereto, thereby affixedly positioning the nozzle over a shunt tube opening to allow fluid to flow from the shunt tube interior through the nozzle via the opening. Additional embodiments generally comprise a substantially tubular sleeve comprising a nozzle, wherein the nozzle sleeve is adapted to be slidingly longitudinally advanced onto a shunt tube and welded thereto, thereby affixedly positioning the nozzle over a shunt tube opening to allow fluid to flow from the shunt tube interior through the nozzle via the opening. In various embodiments, some interior or exterior surfaces of the nozzle cap and/or the nozzle sleeve comprise an erosion resistant and/or low friction material. Methods of utilizing the nozzle cap and providing a nozzle sleeve assembly are provided.

### CROSS-REFERENCE TO RELATED APPLICATIONS

This application claims the benefit of U.S. Provisional Application No. 62/483,730, filed on Apr. 10, 2017, which application is incorporated herein by reference as if reproduced in full below.

### STATEMENT REGARDING FEDERALLY SPONSORED RESEARCH OR DEVELOPMENT

Not applicable.

### FIELD OF THE INVENTION

The present invention relates generally to an apparatus for directing flow from a downhole tubular. More specifically, the present invention encompasses a cap or sleeve which comprises a nozzle, wherein the cap or sleeve is affixable to a shunt tube.

### BACKGROUND

Downhole completion operations commonly require filter screens to restrain flow of sand and particulates existing in the well environment from entering pipe openings. In a common application, shunt tubes are utilized exterior of a base pipe to provide fluid communication downhole independent of flow through the base pipe. In a typical industry embodiment, the shunt tubes are not substantially round tubulars, but rather are more rectangular in shape, having a pair of opposing “wide” sides and a pair of opposing “narrow” sides. In most applications, the shunt tubes are oriented such that the surfaces of the wide sides occupy planes substantially perpendicular to the longitudinal axis of the base pipe, and therefore the surfaces of the narrow sides occupy planes inclusive of or substantially parallel to the longitudinal axis of the base pipe.

As presently practiced, shunt tubes may comprise openings (perforations) in their exterior surfaces, whereby fluid contained in the shunt tube is able to flow through the orifices and into a space exterior to the shunt tube. Examples of such technology are contained in U.S. Pat. No. 4,945,991 to Jones, U.S. Pat. No. 5,113,935 to Jones, et al., and U.S. Pat. No. 5,419,394 to Jones, each of which is incorporated herein by reference in its entirety. Typically, such orifices are disposed in one or both of the narrow sides of the shunt tube.

In one aspect, shunt tube perforations may be equipped with erosion resistant inserts. An example of such technology is contained in U.S. Pat. No. 5,842,516 to Jones, which is incorporated herein by reference in its entirety. As also presently practiced, shunt tube may be equipped with nozzles disposed exterior to the perforations, whereby fluid flow out of the perforations may be directed. Examples of such technology are contained in U.S. Pat. No. 6,059,032 to Jones, U.S. Pat. No. 7,373,989 to Setterberg, Jr., U.S. Pat. No. 7,597,141 to Rouse et al., and U.S. Pat. No. 9,097,104 to Royer et al., and United States Patent Application Publication No. 2008/0314588 by Langlais et al., each of which is incorporated herein by reference in its entirety.

Existing nozzle technologies typically involve a nozzle integral to a shunt tube orifice, or a nozzle welded to the exterior surface of the shunt tube comprising the orifice. In prior art examples comprising welding of a nozzle to a shunt tube over an orifice thereof, the nozzle is welded only to the rectangular surface comprising the orifice.

In one aspect of the present invention, a “cap” comprising a nozzle is affixed to three sides of a shunt tube, whereby the orifice is fluidly communicative with the nozzle. In another aspect of the present invention, a “sleeve” comprising a nozzle is affixed circumferentially about a shunt tube, whereby the orifice is fluidly communicative with the nozzle. In addition, the various cap and sleeve surfaces may comprise an erosion resistant and/or low friction material.

### BRIEF SUMMARY OF THE INVENTION

Embodiments of an apparatus of the present invention generally comprise a substantially “u” shaped cap comprising a nozzle (“nozzle cap”), wherein the nozzle cap is adapted to be longitudinally positioned onto a shunt tube and welded to three sides of the shunt tube, thereby affixedly positioning the nozzle over a shunt tube opening to allow fluid to flow from the shunt tube interior through the nozzle via the opening. In another aspect, embodiments of an apparatus of the present invention generally comprise a substantially tubular sleeve comprising a nozzle (“nozzle sleeve”), wherein the nozzle sleeve is adapted to be slidingly longitudinally advanced onto a shunt tube and welded thereto, thereby affixedly positioning the nozzle over a shunt tube opening to allow fluid to flow from the shunt tube interior through the nozzle via the opening. In various embodiments, at least a portion of the exterior and/or interior surface of the nozzle cap and/or the nozzle sleeve comprises an erosion resistant and/or low friction material. Methods of utilizing the apparatuses are also provided.

### BRIEF DESCRIPTION OF THE DRAWINGS

For a more complete understanding of the exemplary embodiments, reference is now made to the following Description of Exemplary Embodiments of the Invention, taken in conjunction with the accompanying drawings, in which:

FIG. 1 depicts a prior art shunt tube arrangement along the exterior of a pipe segment.

FIG. 2A depicts a view of a portion of a prior art shunt tube.

FIG. 2B depicts an end-on view of the prior art shunt tube portion of FIG. 2A.

FIG. 3A depicts an embodiment of a nozzle cap of the present invention.

FIG. 3B depicts the nozzle cap of FIG. 3A with the nozzle removed.

FIG. 4A depicts an embodiment of a nozzle of an embodiment of a nozzle cap of the present invention.

FIG. 4B depicts an embodiment of a nozzle of an embodiment of a nozzle cap of the present invention.

FIG. 5A depicts a side view of an embodiment of a nozzle cap of the present invention employed with a shunt tube.

FIG. 5B depicts a cross-sectional view of the embodiment of a nozzle cap of the present invention employed with a shunt tube depicted in FIG. 5A.

FIG. 6 depicts an embodiment of a coated nozzle cap of the present invention employed with a shunt tube.

FIG. 7A depicts a top view of the embodiment of a nozzle cap of the present invention employed with a shunt tube depicted in FIG. 5A.

FIG. 7B depicts a cross-sectional view of the embodiment of a nozzle cap of the present invention employed with a shunt tube depicted in FIG. 7A.

FIG. 8A depicts an embodiment of a nozzle sleeve of the present invention.

FIG. 8B depicts the nozzle sleeve of FIG. 8A with the nozzle removed.

FIG. 9A depicts a side view of an embodiment of a nozzle cap of the present invention employed with a shunt tube.

FIG. 9B depicts a cross-sectional view of the embodiment of a nozzle cap of the present invention employed with a shunt tube depicted in FIG. 9A.

FIG. 10 depicts an embodiment of a coated nozzle sleeve of the present invention employed with a shunt tube.

FIG. 11A depicts a top view of the embodiment of a nozzle sleeve of the present invention employed with a shunt tube depicted in FIG. 9A.

FIG. 11B depicts a cross-sectional view of the embodiment of a nozzle cap of the present invention employed with a shunt tube depicted in FIG. 11A.

FIG. 12 depicts an embodiment of a method for utilizing an embodiment of a nozzle cap of the present invention.

FIG. 13 depicts an embodiment of a method for utilizing an embodiment of a nozzle sleeve of the present invention.

### DETAILED DESCRIPTION OF EXEMPLARY EMBODIMENTS OF THE INVENTION

The exemplary embodiments are best understood by referring to the drawings with like numerals being used for like and corresponding parts of the various drawings. Use of relative terms herein, such as “top,” “bottom,” “upper,” “lower,” “right,” “left,” “above,” “below,” and the like, are used for illustrative purposes only and are not intended to limit the invention to a disclosed orientation or arrangement. While embodiments of the present invention are described with particularity for employment with shunt tubes used in downhole drilling operations, it would be understood by one skilled in the art that various embodiments may be used generally with any suitable tubular components.

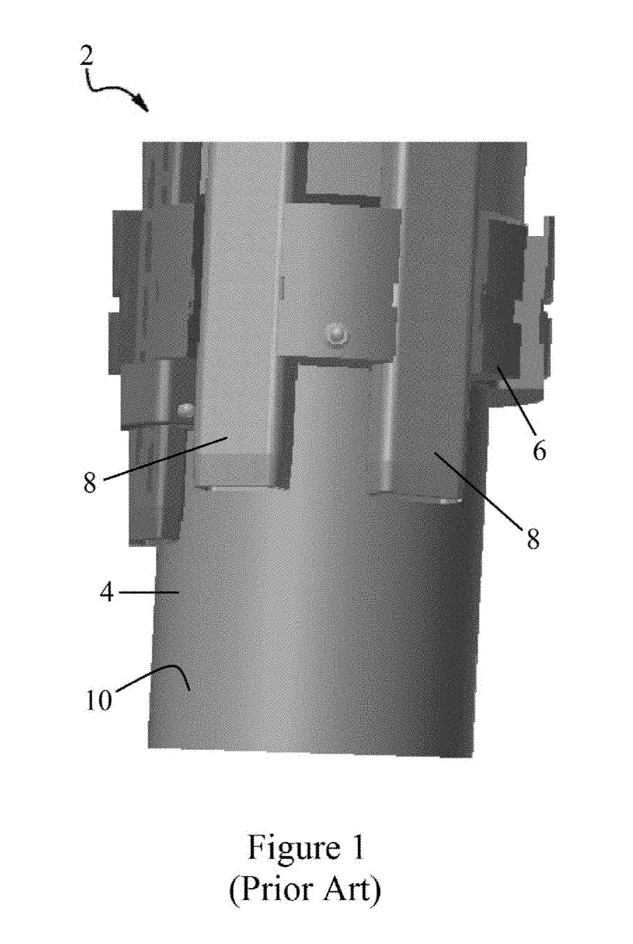

FIG. 1 depicts a prior art downhole piping assembly 2 comprising a piping segment 4, a shunt tube bracket 6, and two tubular shunt tubes 8. In the embodiment of the prior art shown in FIG. 1, each shunt tube 8 is supported longitudinally above the exterior surface 10 of piping segment 4 by shunt tube bracket 6, which is attached to exterior surface 10 of piping segment 4.

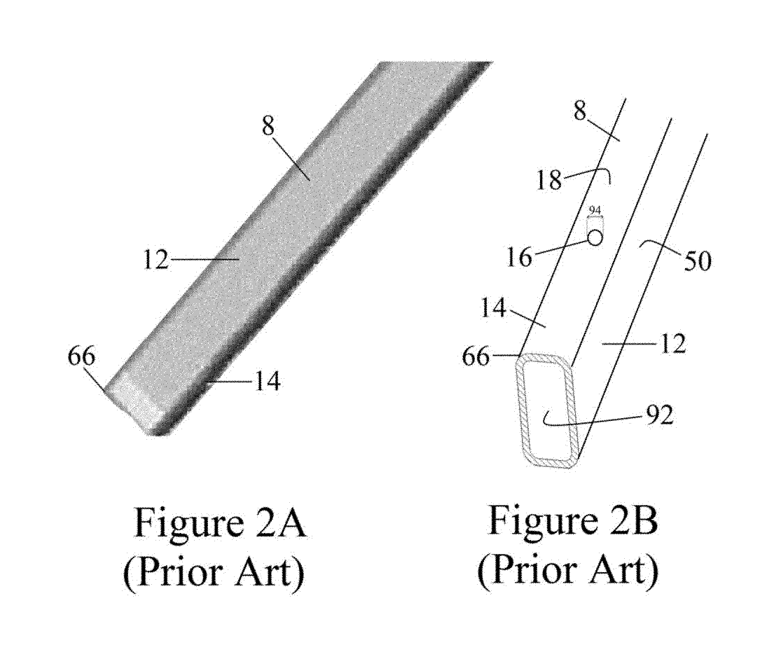

In a typical industry embodiment, the shunt tubes 8 are not substantially round tubulars, but rather are more rectangular in shape. Depicted in FIG. 2A is a portion of a typical prior art shunt tube 8. In the embodiment of FIG. 2A, and as can be better seen in FIG. 2B, the substantially rectangular shunt tube 8 comprises a pair of opposing “wide” sides 12 and a pair of opposing “narrow” sides 14.

In the embodiment of a typical prior art shunt tube 8 depicted in FIG. 2B, shunt tube 8 comprises an opening 16 within an exterior surface 18 of the narrow side 14 thereof extending there through. In various embodiments (not shown), a shunt tube 8 may comprise a plurality of such or similar openings 16. In other embodiments (not shown), a shunt tube 8 may comprise one or more openings 16 within an exterior surface 50 of the wide side 12 thereof. In one aspect, as noted above, such openings (perforations) in the shunt tube 8 allow fluid contained in the shunt tube 8 to flow out through the openings 16 and into a space exterior to the shunt tube 8.

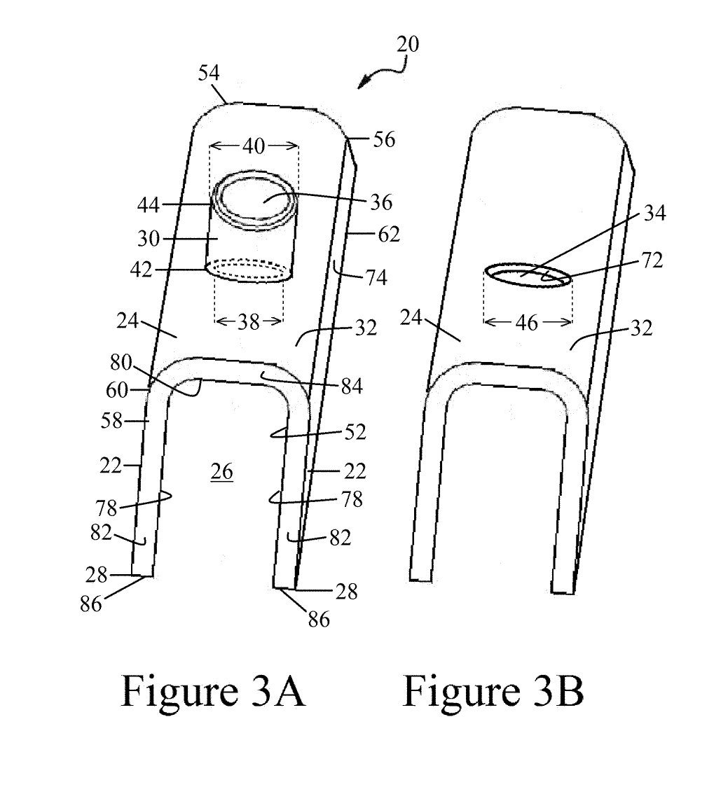

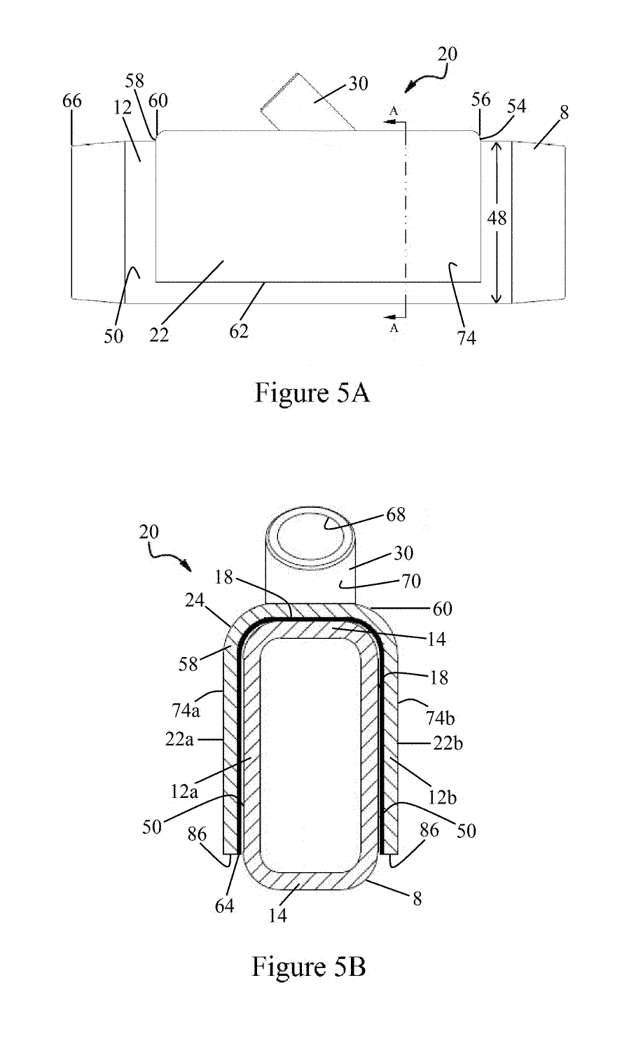

Referring now to FIG. 3A, an embodiment of a nozzle cap 20 of the present invention is depicted. In the embodiment shown in FIG. 3A, the nozzle cap 20 comprises a substantially u-shaped component comprising opposing “wide” sides 22 connected by a “narrow” side 24, wherein the wide sides 22 are oriented substantially perpendicular to the narrow side 24. In other embodiments (not shown), a substantially u-shaped nozzle cap 20 may comprise opposing narrow sides connected by a wide side. In one embodiment, a nozzle cap 20 comprises metals and/or metal alloys. In some embodiments, a nozzle cap 20 comprises 316L stainless steel, 304L stainless steel, L80 steel, carbon steel, and/or cast iron. In one embodiment, wide sides 22 and narrow side 24 define a substantially rectangular void 26 between narrow side 24 and ends 28 of wide sides 22. In one aspect, a nozzle cap 20 is sized and configured such that it fits snugly around a circumferential portion of a shunt tube 8; i.e., a circumferential portion of a shunt tube 8 fits snugly longitudinally within void 26, as shown in, for example, FIG. 5B.

Again referring to FIG. 3A, in one embodiment, a nozzle cap 20 comprises a nozzle 30 disposed along narrow side 24 thereof. In one embodiment, a nozzle 30 comprises a substantially tubular component, although as described below, other configurations/geometries of nozzle 30 may be employed. A nozzle 30 may be affixed to the exterior surface 32 of narrow side 24, or may be integral with nozzle cap 20. In one embodiment, a nozzle 30 comprises metals and/or metal alloys. In one embodiment, a nozzle 30 comprises 316L stainless steel, 304L stainless steel, L80 steel, carbon steel, and/or cast iron. In other embodiments (not shown), a nozzle cap 20 may comprise a nozzle 30 disposed along a wide side 22 thereof.

In one embodiment, a nozzle 30 is positioned above an orifice 34 disposed in exterior surface 32 of narrow side 24, as visible in FIG. 3B which depicts the nozzle cap 20 of FIG. 3A with the nozzle 30 removed. In various embodiments, nozzle 30 may be affixed to exterior surface 32, such as by welding, or nozzle 30 may be integral to nozzle cap 20. In one embodiment, nozzle 30 is centered above orifice 34, and orifice 34 is thereby fluidly connected to the interior 36 of nozzle 30. In one embodiment, orifice 34 is substantially round, although other geometries are employable. In one embodiment, the diameter 46 of the orifice 34 is substantially equal to the diameter 94 of the opening 16 of the shunt tube 8. (See FIG. 2B). In one embodiment, the interior 36 of nozzle 30 comprises a substantially uniform internal diameter 38 and/or external diameter 40 from a proximal end 42 of nozzle 30 to a distal end 44 of nozzle 30, although other geometries are employable. In one embodiment, proximal end 42 of nozzle 30 comprises an internal diameter 38 substantially equal to the diameter 46 of orifice 34.

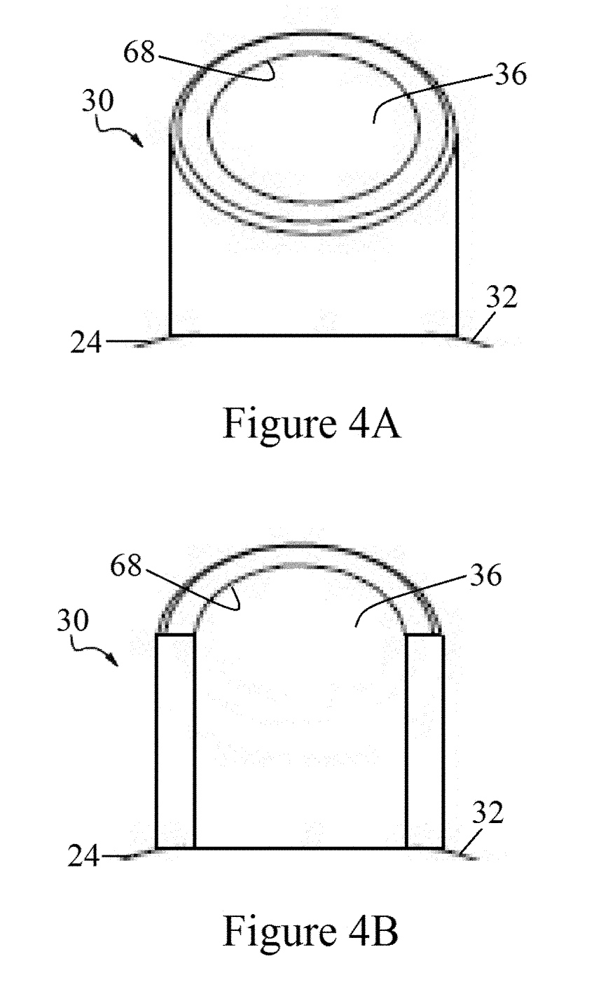

Referring now to FIGS. 4A and 4B, embodiments of nozzle 30 are depicted therein. In the embodiment shown in FIG. 4A, nozzle 30 comprises a tubular geometry. Although the embodiment of nozzle 30 depicted in FIG. 4A comprises a substantially circular tubular geometry, the invention is not so limited and other embodiments, including but not limited to oval, square, or rectangular tubular geometries, may be employed. In other embodiments, including but not limited to the embodiment shown in FIG. 4B, nozzle 30 comprises a non-tubular geometry. In the embodiment of FIG. 4B, nozzle 30 comprises a substantially semi-circular (half-pipe) geometry. In other embodiments (not shown), a non-tubular nozzle 30 may comprise a partially circular (arc) geometry, comprising an arc length greater than or less than a semi-circle. In further embodiments (not shown), a non-tubular nozzle 30 may comprise a non-circular, concave geometry, such as, but not limited to, a u-shaped geometry. In still other embodiments (not shown), a non-tubular nozzle 30 may comprise a plurality of separate components extending outwardly from exterior surface 32. In other embodiments (not shown), a nozzle 30 may comprise a single flat or convex component extending outwardly from exterior surface 32.

Referring now to FIG. 5A, an embodiment of a nozzle cap 20 is shown attached to a shunt tube 8. In the side view of FIG. 5A can be seen a wide side 22 of nozzle cap 20 extending along a wide side 12 of the shunt tube 8. In the embodiment of FIG. 5A, nozzle cap 20 wide side 22 extends along substantially the entire width 48 shunt tube 8 wide side 12, however the invention is not so limited and a wide side 22 of nozzle cap 20 may extend along any portion, or the entirety, of a wide side 12.

In one embodiment, a nozzle cap 20 may be affixed to a shunt tube 8. In one embodiment, an adhesive material may be used to affix at least a portion of an interior surface 52 of a nozzle cap 20 to the exterior surface 18 and/or exterior surfaces 50 of shunt tube 8 In one embodiment, a nozzle cap 20 may be affixed to a shunt tube 8 along at least a portion of a transverse edge 54 of a first end 56 of nozzle cap 20, a transverse edge 58 of a second end 60 of nozzle cap 20, and/or a longitudinal edge 62 of one or both wide sides 22 of nozzle cap 20. In one embodiment, affixation along one or more of edges 54, 58, and 62 may comprise welding, such as, but not limited to, tungsten inert gas (TIG) welding. In one embodiment, affixation of nozzle cap 20 to shunt tube 8 provides a fluid seal between wide sides 22 and exterior surfaces 50, and between narrow side 24 and an exterior surface 18.

Referring now to FIG. 5B, which is a cross-sectional view of the embodiment depicted in FIG. 5A along axis A-A, the positioning of nozzle cap 20 about shunt tube 8 is shown. In the embodiment of FIG. 5B, nozzle cap 20 wide sides 22a, 22b extend equidistantly along shunt tube 8 wide sides 12a, 12b, respectively, but the invention is not so limited and embodiments wherein wide sides 22a, 22b do not extend equidistantly along shunt wide sides 12a, 12b, respectively, are employable.

Referring again to the embodiment depicted in FIG. 5A, nozzle 30 is configured to direct fluid (not shown) flowing there through at least partially in the direction of second end 60 of nozzle cap 20, and hence at least partially in the direction of an end 66 of shunt tube 8. In various embodiments, end 66 of shunt tube 8 may be the “downhole” end thereof or the “up-hole” end thereof, as those terms would be understood by one skilled in the art. In additional embodiments (not shown), other orientations of nozzle 30 with regard to shunt tube 8 may be employed.

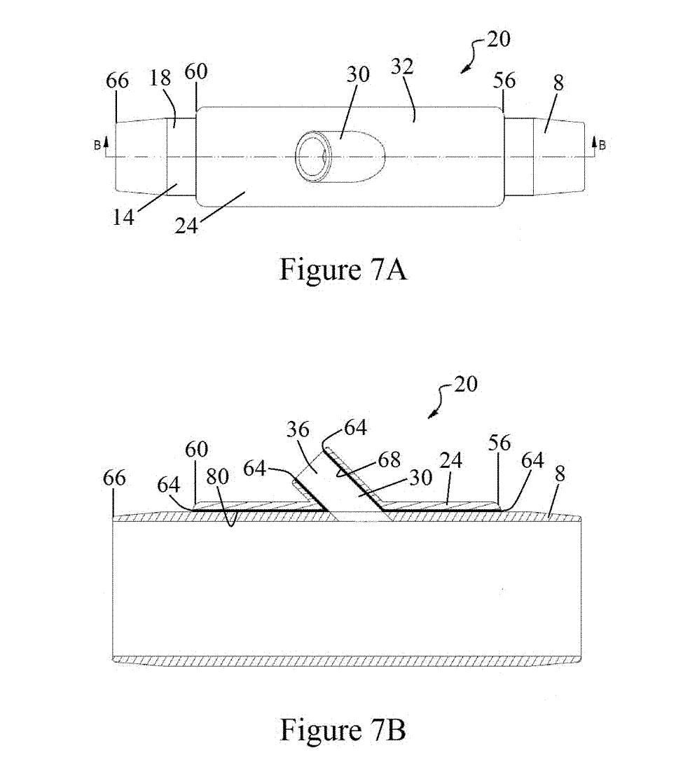

In one aspect, embodiments of nozzle cap 20 comprise an erosion resistant and/or low-friction material coating 64 on interior and/or exterior surfaces thereof. (See FIGS. 5B and 7B). Some examples of coating materials are disclosed in U.S. Pat. No. 8,261,841 to Bailey et al., which patent is incorporated herein by reference as if reproduced in full herein. In one embodiment, the coating material comprises a diamond-like-carbon (DLC) material. In one embodiment, the coating material comprises a carbide material. In one embodiment, a coating layer may be provided by nickel powder coating or plasma transfer arc hardfacing. In one embodiment, a coating layer has a thickness of about 0.5-50 μm. In one embodiment, multiple layers of coating material may be employed, and the coating layers may comprise the same or different coating materials. In one embodiment, a coated nozzle cap 20 surface exhibits a hardness in the range of 25-95 on the Rockwall C (HRC) scale.

In various embodiments of nozzle cap 20, an erosion resistant and/or low-friction coating material may be employed on at least a portion of an interior surface 68 of nozzle 30, an exterior surface 70 of nozzle 30, an inner surface 72 of orifice 34, an exterior surface 74 of one or both wide sides 22 of nozzle cap 20, an end surface 76 of nozzle 30, an interior surface 78 of one or both wide sides 22 of nozzle cap 20, an interior surface 80 of narrow side 24 of nozzle cap 20, an end edge surface 82 of one or both wide sides 22 of nozzle cap 20, an end edge surface 84 of narrow side 24 of nozzle cap 20, a bottom edge surface 86 of one or both wide side 22 of nozzle cap 20, and/or exterior surface 32 of narrow side 24 of nozzle cap 20. In addition, coating layers disposed on interior surface 68, exterior surface 70, inner surface 72, exterior surface(s) 74, end surface 76, interior surface(s) 78, interior surface 80, end edge surface 82, end edge surface 84, bottom edge surface(s) 86, and/or exterior surface 32 may comprise the same or different coating materials.

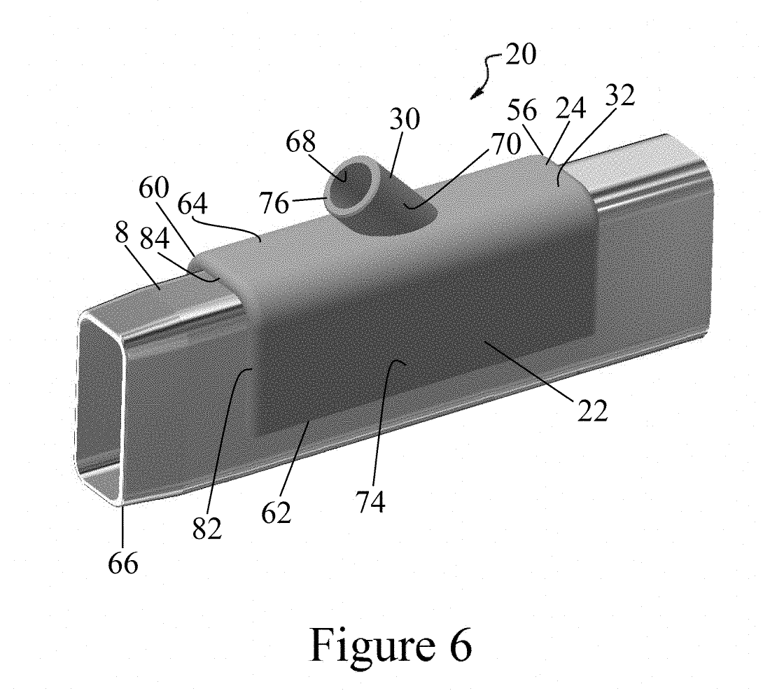

An embodiment of a coated nozzle cap 20 positioned about a shunt tube 8 is depicted in FIG. 6. In this embodiment, a coating 64 is shown disposed on exterior surface 32 of narrow side 24 of nozzle cap 20, exterior surface 74 of the visible wide side 22 of nozzle cap 20, interior surface 68 of nozzle 30, exterior surface 70 of nozzle 30, end surface 76 of nozzle 30, visible end edge surface 84 of narrow side 24, and visible end edge surface 82 of visible wide side 22.

In FIGS. 7A and 7B, additional views of an embodiment of a nozzle cap 20 equipped shunt tube 8 are depicted. In FIG. 7A, a top view of a nozzle cap 20 positioned about a shunt tube 8 is shown. FIG. 7B is a cross-sectional view of the embodiment depicted in FIG. 7A along axis B-B. In this embodiment, a coating material 64 disposed on the interior surface 68 of nozzle 30 and on the interior surface 80 of narrow side 24 of nozzle cap 20 is visible.

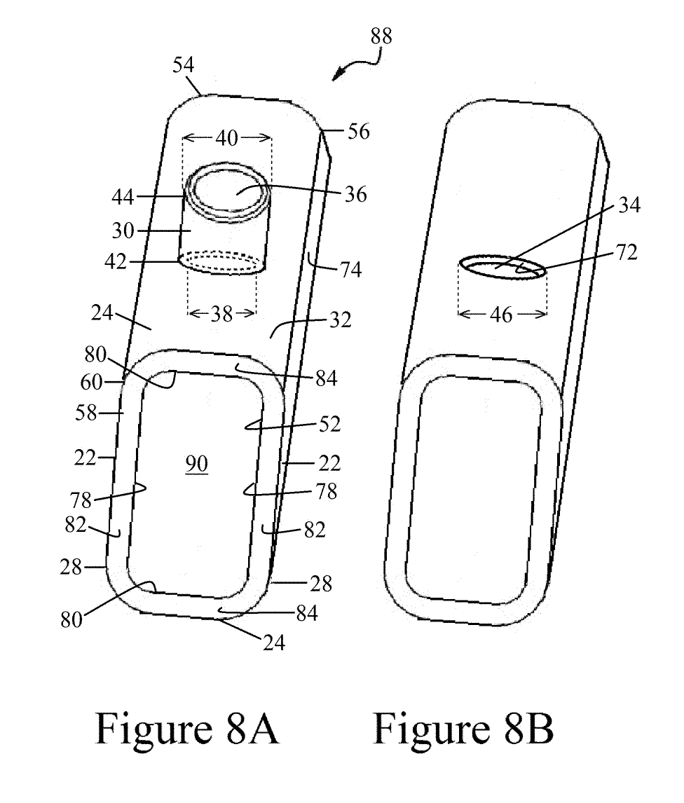

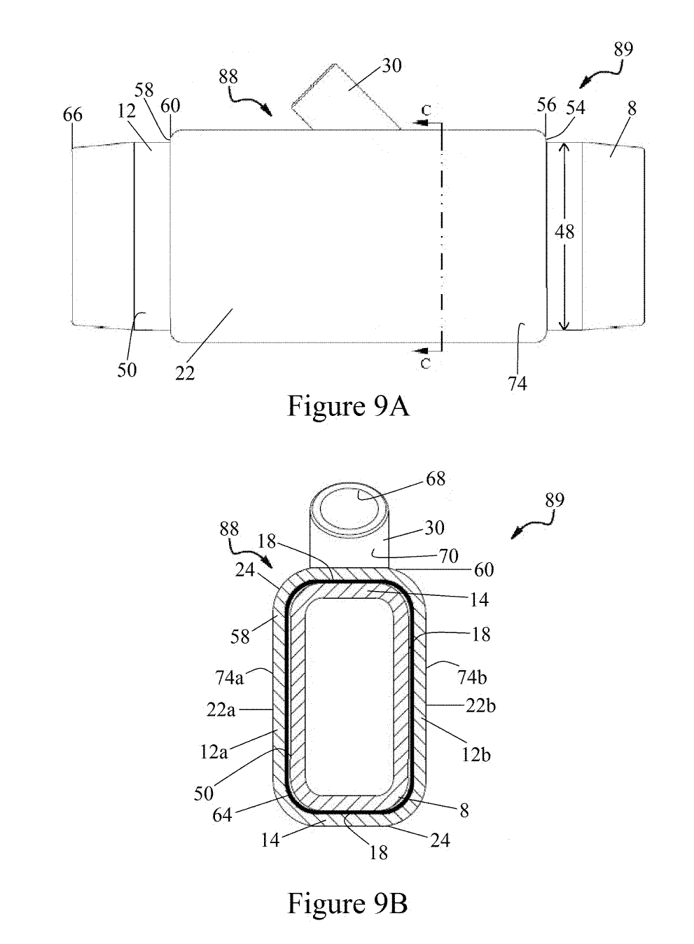

In another aspect of the invention, embodiments of a nozzle sleeve 88 comprising a nozzle 30 are disclosed. In one embodiment, shown in FIG. 8A, a nozzle sleeve 88 comprises a substantially tubular, substantially rectangularly shaped component comprising opposing wide sides 22 connected by opposing narrow sides 24, wherein a nozzle 30 is disposed along one narrow side 24. In other embodiments (not shown), a substantially tubular, substantially rectangularly shaped nozzle sleeve 88 may comprise opposing narrow sides 22 connected by wide sides 24, wherein a nozzle 30 is disposed along one wide side 22. In one embodiment, a nozzle sleeve 88 comprises metals and/or metal alloys. In one embodiment, a nozzle sleeve 88 comprises 316L stainless steel, 304L stainless steel, L80 steel, carbon steel, and/or cast iron. In one embodiment, wide sides 22 and narrow sides 24 define a substantially rectangular internal cavity 90. In one aspect, a nozzle sleeve 88 is sized and configured such that it can be longitudinally slidingly advanced onto and along a shunt tube 8 and fits snugly around a circumferential portion of the shunt tube 8; i.e., a circumferential portion of a shunt tube 8 fits snugly longitudinally within cavity 88, as shown in, for example, FIG. 9B.

Additional nozzle sleeve 88 features as identified in FIGS. 8A, and 8B (which is analogous to FIG. 5B), possess the qualities and characteristics described therefor above regarding nozzle cap 20.

In one embodiment, a nozzle 30 is positioned above an orifice 34 disposed in exterior surface 32 of narrow side 24, as visible in FIG. 8B which depicts the nozzle sleeve 88 of FIG. 3A with the nozzle 30 removed. In various embodiments, nozzle 30 may be affixed to exterior surface 32, such as by welding, or nozzle 30 may be integral to nozzle sleeve 88. In one embodiment, orifice 34 is fluidly connected with the interior 36 of nozzle 30. In one embodiment, orifice 34 is substantially round, although other geometries are employable. In one embodiment, the diameter 46 of the orifice 34 is substantially equal to the diameter 94 of the opening 16 of the shunt tube 8. In one embodiment, the interior 36 of nozzle 30 comprises a substantially uniform internal diameter 38 and/or external diameter 40 from a proximal end 42 of nozzle 30 to a distal end 44 of nozzle 30, although other geometries are employable. In one embodiment, proximal end 42 of nozzle 30 comprises an internal diameter 38 substantially equal to the diameter 46 of orifice 34.

Additional features of nozzles 30 employable with embodiments of a nozzle sleeve 88 of the present invention possess the qualities and characteristics described therefor above regarding nozzle cap 20, and as depicted in FIGS. 4A and 4B.

Referring now to FIG. 9A, an embodiment of a nozzle sleeve 88 is shown attached to a shunt tube 8, thereby forming a nozzle sleeve assembly 89. In the side view of FIG. 9A can be seen a wide side 22 of nozzle sleeve 88 extending along the entirety of a wide side 12 of the shunt tube 8. As shown in FIG. 9B, the wide side 22 visible in FIG. 9A constitutes a portion of the nozzle sleeve 88 which extends circumferentially around the shunt tube 8.

In one embodiment of a nozzle sleeve assembly 89, a nozzle sleeve 88 may be affixed to a shunt tube 8. In one embodiment, an adhesive material may be used to affix at least a portion of an interior surface 52 of a nozzle sleeve 88 to the exterior surfaces 18 and/or exterior surfaces 50 of shunt tube 8. In one embodiment, a nozzle sleeve 88 may be affixed to a shunt tube 8 along at least a portion of a transverse edge 54 of a first end 56 of nozzle sleeve 88 and/or a transverse edge 58 of a second end 60 of nozzle sleeve 88. In one embodiment, affixation along one or more of edges 54 and 58 may comprise welding, such as, but not limited to, tungsten inert gas (TIG) welding. In one embodiment, affixation of nozzle sleeve 88 to shunt tube 8 provides a fluid seal between wide sides 22 and exterior surfaces 50, and between narrow sides 24 and exterior surfaces 18.

Referring now to FIG. 9B, which is a cross-sectional view of the embodiment depicted in FIG. 9A along axis C-C, the positioning of nozzle sleeve 88 about shunt tube 8 is shown. As shown in the embodiment of FIG. 9B, the nozzle sleeve 88 extends entirely circumferentially around the shunt tube 8.

Referring again to the embodiment depicted in FIG. 9A, nozzle 30 is configured to direct fluid (not shown) flowing there through at least partially in the direction of second end 60 of nozzle sleeve 88, and hence at least partially in the direction of an end 66 of shunt tube 8. In various embodiments, end 66 of shunt tube 8 may be the “downhole” end thereof or the “up-hole” end thereof, as those terms would be understood by one skilled in the art. In additional embodiments (not shown), other orientations of nozzle 30 with regard to shunt tube 8 may be employed.

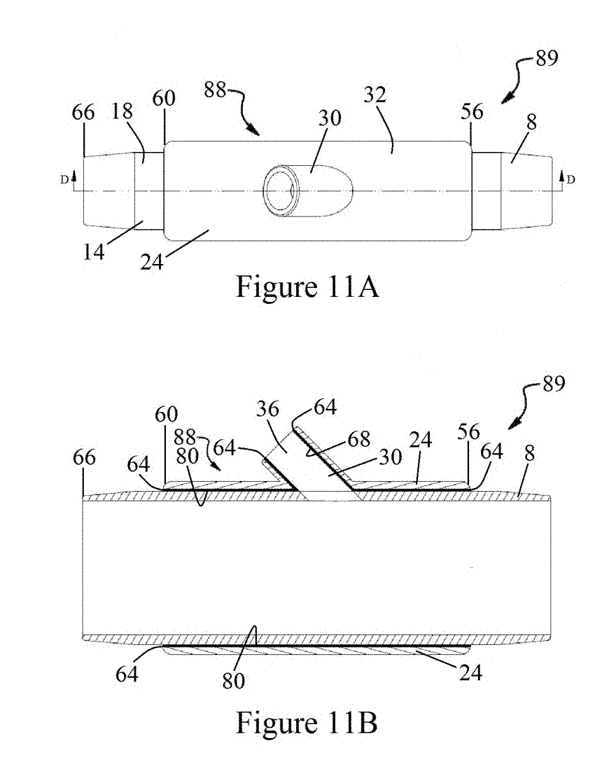

In one aspect, embodiments of nozzle sleeve 88 comprise an erosion resistant and/or low-friction material coating 64 on interior and/or exterior surfaces thereof. (See FIGS. 9B and 11B). Coating materials 64 employable with embodiments of a nozzle sleeve 88 of the present invention possess the qualities and characteristics described therefor above regarding nozzle cap 20 In one embodiment, a coating layer has a thickness of about 0.5-50 μm. In one embodiment, multiple layers of coating material may be employed, and the coating layers may comprise the same or different coating materials. In one embodiment, a coated nozzle sleeve 88 surface exhibits a hardness in the range of 25-95 on the Rockwall C (HRC) scale.

In various embodiments of nozzle sleeve 88, an erosion resistant and/or low-friction coating material may be employed on at least a portion of the interior surface 68 of nozzle 30, the exterior surface 70 of nozzle 30, the inner surface 72 of orifice 34, the exterior surface 74 of one or both wide sides 22 of nozzle sleeve 88, the end surface 76 of nozzle 30, the interior surface 78 of one or both wide sides 22 of nozzle sleeve 88, the interior surface 80 of one or both narrow sides 24 of nozzle sleeve 88, the end edge surface 82 of one or both wide sides 22 of nozzle sleeve 88, the end edge surface 84 of one or both narrow sides 24 of nozzle sleeve 88, and/or the exterior surface 32 of one or both narrow sides 24 of nozzle sleeve 88. In addition, coating layers disposed on interior surface 68, exterior surface 70, inner surface 72, exterior surface(s) 74, end surface 76, interior surface(s) 78, interior surface 80, end edge surface 82, end edge surface 84, and/or exterior surface(s) 32 may comprise the same or different coating materials.

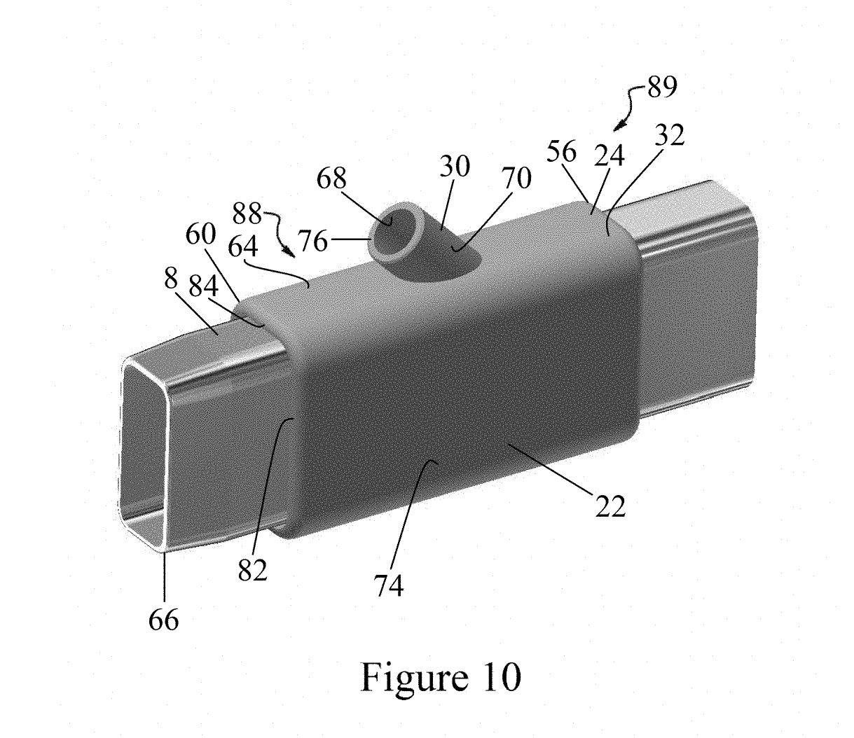

An embodiment of a coated nozzle sleeve 88 positioned about a shunt tube 8 is depicted in FIG. 10. In this embodiment, a coating 64 is shown disposed on exterior surface 32 of the visible narrow side 24 of nozzle cap 20, exterior surface 74 of the visible wide side 22 of nozzle cap 20, interior surface 68 of nozzle 30, exterior surface 70 of nozzle 30, end surface 76 of nozzle 30, visible end edge surface 84 of visible narrow side 24, and visible end edge surface 82 of visible wide side 22.

In FIGS. 11A and 11B, additional views of an embodiment of a nozzle sleeve 88 equipped shunt tube 8 are depicted. In FIG. 11A, a top view of a nozzle sleeve 88 positioned about a shunt tube 8 is shown. FIG. 11B is a cross-sectional view of the embodiment depicted in FIG. 11A along axis D-D. In this embodiment, a coating material 64 disposed on the interior surface 68 of nozzle 30 and on the interior surface 80 of both narrow sides 24 of nozzle sleeve 88 is visible.

### Operation

In an embodiment of an employment of an embodiment of a nozzle cap 20 of the present invention, a shunt tube 8 comprising at least one opening 16 in a narrow side 14 thereof is provided. A suitably dimensioned nozzle cap 20 comprising a nozzle 30 is longitudinally aligned with and positioned above the shunt tube 8, whereby the void 26 is positioned above that narrow side 14 with ends 28 of wide sides 22 of nozzle cap 20 proximate the shunt tube 8. The nozzle cap 20 is then fitted over the shunt tube 8 so that the orifice 34, which is fluidly connected to nozzle 30 at the proximal end 42 thereof, is proximate to an opening 16 of the shunt tube 8. The nozzle cap 20 is axially positionally adjusted along the shunt tube 8 to dispose the shunt tube 8 snugly within the void 26 and/or provide the orifice 34 substantially centered over the shunt tube 8 opening 16, wherein at least a portion of the interior surface 80 of narrow side 24 of the nozzle cap 20 contacts the exterior surface 18 of the shunt tube 8 narrow side 14 comprising that opening 16, and at least a portion of each interior surface 78 of wide sides 22 of nozzle cap 20 contacts the exterior surface 50 of a wide side 12 of the shunt tube 8, and whereby fluid communication is provided between the interior 92 of the shunt tube 8 and the interior 36 of nozzle 30, via opening 16 of the shunt tube 8 and orifice 34 of the nozzle cap 20. In one embodiment, the nozzle cap 20 is then welded to the exterior of the shunt tube along at least a portion of one or more of the edges 54, 58, and 62 of the nozzle cap 20.

In an embodiment of an employment of an embodiment of a nozzle sleeve 88 of the present invention, a shunt tube 8 comprising at least one opening 16 in a narrow side 14 thereof is provided. A suitably dimensioned nozzle sleeve 88 comprising a nozzle 30 is longitudinally aligned with the shunt tube 8 whereby an end 56 of the sleeve nozzle 88 is positioned proximate an end 66 of the shunt tube 8, and whereby the narrow side 24 of nozzle sleeve 88 equipped with the nozzle 30 is longitudinally aligned with a narrow side 14 of the shunt tube 8 comprising one or more openings 16. The nozzle sleeve 88 is then longitudinally slidingly advanced onto the shunt tube 8 whereby a portion of shunt tube 8 is disposed within internal cavity 90 of nozzle sleeve 88, until the orifice 34, which is fluidly connected with nozzle 30 at the proximal end 42 thereof, is substantially centered over an opening 16 of the shunt tube 8, thereby providing the nozzle sleeve assembly 89, and whereby fluid communication is provided between the interior 92 of the shunt tube 8 and the interior 36 of nozzle 30, via opening 16 of the shunt tube 8 and orifice 34 of the nozzle cap 20. In one embodiment, the nozzle sleeve 88 is then welded to the exterior of the shunt tube along at least a portion of one or more of the edges 54 and 58 the nozzle sleeve 88.

### Method

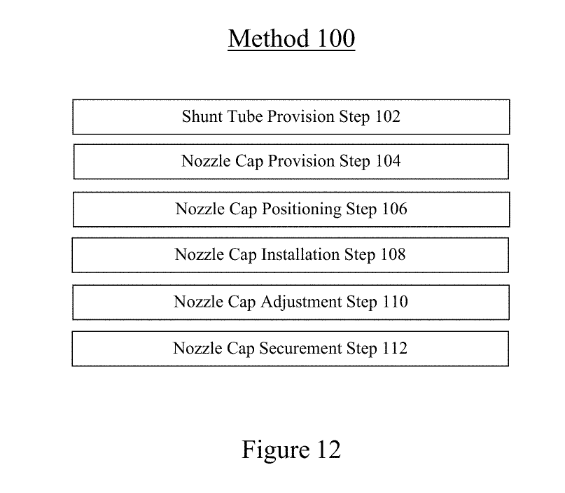

In one embodiment, depicted in FIG. 12, a method 100 of the present invention for utilizing an embodiment of a nozzle cap 20 of the present invention comprises the following steps:

A Shunt Tube Provision Step 102, comprising providing a substantially rectangular shunt tube, such as a shunt tube 8, wherein the shunt tube comprises an opening, such as an opening 16, in a side of the shunt tube, such as a narrow side 14 or a wide side 12 thereof.

A Nozzle Cap Provision Step 104, comprising providing a substantially u-shaped nozzle cap, such as a nozzle cap 20, comprising a nozzle, such as a nozzle 30, positioned on a nozzle cap side exterior surface, such as an exterior surface 32 or 74, whereby a void, such as a void 26, exists beneath a first nozzle cap side equipped with the nozzle, and two opposing nozzle cap sides, such as sides 22 or 24, extending substantially perpendicularly from the first nozzle cap side.

A Nozzle Cap Positioning Step 106, comprising positioning the nozzle cap void proximate to and in longitudinal alignment with the shunt tube side comprising the opening, wherein a nozzle cap orifice, such as an orifice 34, which is fluidly connected to the nozzle at a proximal end, such as proximal end 42, thereof, is disposed proximate the shunt tube opening.

A Nozzle Cap Installation Step 108, comprising longitudinally engaging the nozzle cap with the shunt tube, whereby a portion of the shunt tube is disposed within the nozzle cap void, such that at least a portion of the interior surface of the nozzle cap side equipped with the nozzle contacts the exterior surface of the shunt tube side comprising the opening, and at least a portion of each interior surface, such as interior surfaces 78 or 80, of the sides of the nozzle cap not equipped with the nozzle contacts the exterior surface of a side of the shunt tube oriented substantially perpendicular to the shunt tube side comprising the opening, and whereby the orifice of the proximal end of the nozzle is disposed proximate to the shunt tube opening

A Nozzle Cap Adjustment Step 110, comprising longitudinally positionally adjusting the nozzle cap along the shunt tube so that the nozzle cap orifice is substantially centered above the shunt tube opening, whereby fluid communication is provided between the interior of the shunt tube and the interior of the nozzle, via the opening and the orifice.

A Nozzle Cap Securement Step 112, comprising affixing the nozzle cap to the shunt tube.

Method 100 is merely exemplary, and additional embodiments of a method of utilizing embodiments of a nozzle cap 20 of the present invention consistent with the teachings herein may be employed. In addition, in other embodiments, one or more of these steps may be combined, repeated, re-ordered, or deleted, and/or additional steps may be added.

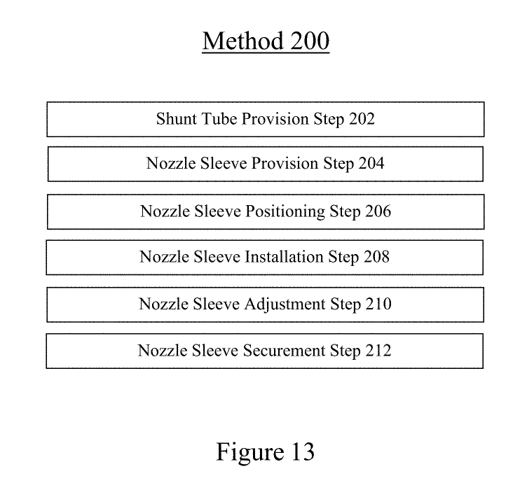

In one embodiment, depicted in FIG. 13, a method 200 of the present invention for utilizing an embodiment of a nozzle sleeve 88 of the present invention to provide a nozzle sleeve assembly 89 comprises the following steps:

A Shunt Tube Provision Step 202, comprising providing a substantially rectangular shunt tube, such as a shunt tube 8, wherein the shunt tube comprises an opening, such as an opening 16, in a side of the shunt tube, such as a narrow side 14 or a wide side 12 thereof.

A Nozzle Sleeve Provision Step 204, comprising providing a substantially tubular, substantially rectangularly shaped nozzle sleeve, such as a nozzle sleeve 88, comprising a nozzle, such as a nozzle 30, positioned on a nozzle sleeve side exterior surface, such as an exterior surface 32 or 74, and comprising a substantially rectangular internal cavity, such as a cavity 90.

A Nozzle Sleeve Positioning Step 206, comprising positioning the nozzle sleeve cavity proximate to and in longitudinal alignment with the shunt tube, whereby an end, such as end 56, of the sleeve nozzle is positioned proximate an end, such as end 66, of the shunt tube, and whereby the side of the nozzle sleeve equipped with the nozzle is longitudinally aligned with the side of the shunt tube comprising the opening.

A Nozzle Sleeve Installation Step 208, comprising longitudinally slidingly advancing the nozzle sleeve onto the shunt tube, whereby a portion of shunt tube is disposed within the internal cavity of the nozzle sleeve,

A Nozzle Sleeve Adjustment Step 210, comprising longitudinally positionally adjusting the nozzle sleeve along the shunt tube so that a nozzle cap orifice, such as orifice 34, which is fluidly connected to the nozzle at a proximal end, such as proximal end 42, thereof, is substantially centered over the shunt tube opening, and whereby fluid communication is provided between the interior of the shunt tube and the interior of the nozzle, via the opening and the orifice.

A Nozzle Sleeve Securement Step 212, comprising affixing the nozzle sleeve to the shunt tube.

Method 200 is merely exemplary, and additional embodiments of a method of utilizing embodiments of a nozzle sleeve 88 of the present invention consistent with the teachings herein may be employed. In addition, in other embodiments, one or more of these steps may be combined, repeated, re-ordered, or deleted, and/or additional steps may be added.

While the preferred embodiments of the invention have been described and illustrated, modifications thereof can be made by one skilled in the art without departing from the teachings of the invention. Descriptions of embodiments are exemplary and not limiting. Disclosure of existing patents, publications, and known art are incorporated herein by reference to the extent required to provide details and understanding of the disclosure herein set forth.

We claim:

1. A nozzle cap, comprising:
a substantially u-shaped component comprising:
a substantially planar first side; and
two substantially planar second sides; and
a substantially tubular nozzle;
wherein:
said first side comprises a first face and a second face;
said second sides are oriented substantially perpendicularly to said first side and both said second sides extend away from said second face;
said nozzle extends from said second face;
an interior of said nozzle is fluidly connected to an orifice extending through said first face and said second face; and
at least a portion of one or more surfaces of said nozzle cap comprises a coating material having properties selected from the group consisting of:
erosion resistant;
low friction; and
both erosion resistant and low friction.

2. The nozzle cap of claim 1, wherein said coating material comprises a diamond-like-carbon (DLC) material.

3. The nozzle cap of claim 1, wherein said coating material is provided on at least one said nozzle cap surface by nickel powder coating or plasma transfer arc hardfacing.

4. The nozzle cap of claim 1, wherein said coating material has a thickness of about 0.5 μm to about 50 μm.

5. The nozzle cap of claim 1, wherein said nozzle is non-tubular.

6. The nozzle cap of claim 1, wherein said nozzle cap is axially positioned about a substantially externally rectangular tubular structure comprising an opening extending through the wall thereof, wherein said tubular structure opening is aligned with said nozzle orifice, whereby said interior of said nozzle is fluidly connected to the interior of said tubular structure.

7. The nozzle cap of claim 6, wherein said nozzle cap is affixed to said substantially externally rectangular tubular structure.

8. The nozzle cap of claim 7, wherein said nozzle cap is affixed to said substantially externally rectangular tubular structure by welding at least a portion of said nozzle cap thereto.

9. A nozzle sleeve assembly, comprising:
a nozzle sleeve comprising:
a first substantially internally rectangular tubular component comprising:
two substantially planar first sides; and
two substantially planar second sides; and
a substantially tubular nozzle; and
a second substantially externally rectangular tubular component;
wherein:
one said first side comprises an interior face and an exterior face;
said nozzle extends outwardly from said exterior face;
an interior of said nozzle is fluidly connected to an orifice extending through said interior face and said exterior face;
said second substantially externally rectangular tubular component is axially positioned at least partially within said first internally substantially rectangular tubular component;
said second substantially externally rectangular tubular component comprises an opening extending through the wall thereof, wherein said tubular components are axially aligned such that said opening is aligned with said nozzle sleeve orifice, whereby said interior of said nozzle is fluidly connected to the interior of said second substantially externally rectangular tubular component via said opening and said orifice; and
at least a portion of one or more surfaces of said nozzle sleeve comprises a coating material having properties selected from the group consisting of:
erosion resistant;
low friction; and
both erosion resistant and low friction.

10. The nozzle sleeve assembly of claim 9, wherein said coating material comprises a diamond-like-carbon (DLC) material.

11. The nozzle sleeve assembly of claim 9, wherein said coating material has a thickness of about 0.5 μm to about 50 μm.

12. The nozzle sleeve assembly of claim 9, wherein said nozzle is non-tubular.

13. The nozzle sleeve assembly of claim 9, wherein said nozzle sleeve is affixed to said second substantially rectangular tubular component.

14. The nozzle sleeve assembly of claim 13, wherein said nozzle sleeve is affixed to said second substantially rectangular tubular component by welding at least a portion of said nozzle sleeve thereto.

15. A method of utilizing a nozzle cap, comprising:
providing the nozzle cap of claim 1;
providing a substantially externally rectangular tubular structure comprising an opening in the wall thereof extending there through; and
longitudinally attaching said nozzle cap to said substantially externally rectangular tubular structure, whereby said orifice is positioned in fluid communication with said opening, and whereby the interior of said substantially externally rectangular tubular structure is fluidly connected to said interior of said nozzle via said opening and said orifice.

16. The method of claim 15, comprising affixing said nozzle cap to said substantially externally rectangular tubular structure.

17. The method of claim 16, wherein said nozzle cap is affixed to said substantially externally rectangular tubular structure by welding at least a portion of said nozzle cap thereto.

18. A method of providing a nozzle sleeve assembly, comprising:
providing a nozzle sleeve comprising:
a first substantially internally rectangular tubular component comprising:
two substantially planar first sides; and
two substantially planar second sides; and
a substantially tubular nozzle;
providing a second substantially externally rectangular tubular component comprising an opening in a surface thereof extending there through; and
slidingly longitudinally advancing said nozzle sleeve circumferentially around said second substantially externally rectangular tubular component, whereby said orifice is positioned in fluid communication with said opening, and whereby the interior of said second substantially externally rectangular tubular component is fluidly connected to the interior of said nozzle via said opening and said orifice.

19. The method of claim 18, comprising affixing said nozzle sleeve to said second substantially externally rectangular tubular component.

20. The method of claim 19, comprising wherein said nozzle sleeve is affixed to said second substantially rectangular tubular component by welding at least a portion of said nozzle sleeve thereto.
